(19) United States
(12) Patent Application Publication
(10) Pub. No.: US 2026/0233628 A1
(43) Pub. Date: Aug. 13, 2026

(54) ENERGY SUPPLY- AND DEMAND-BASED CONFIGURATION AND OPERATION OF ELECTRIC VEHICLES

(71) Applicant: Intel Corporation, Santa Clara, CA (US)

(72) Inventors: Cornelius BUERKLE, Karlsruhe (DE); Fabian OBORIL, Karlsruhe (DE); Frederik PASCH, Karlsruhe (DE)

(21) Appl. No.: 19/154,391

(22) PCT Filed: Oct. 26, 2023
(86) PCT No.: PCT/EP2023/079937

§ 371 Date: Aug. 7, 2025

(30) Foreign Application Priority Data
Mar. 22, 2023 (DE) 10 2023 107 223.4

(51) Int. Cl. B60L 53/64; B60L 53/66; B60L 55/00

(52) U.S. Cl. CPC B60L 53/64; B60L 53/665; B60L 55/00; B60L 2260/52; B60L 2260/54

(57) ABSTRACT

Disclosed herein are devices, methods, and systems for configuring a vehicle according to energy requirements of a supply of energy (e.g., an electric grid). An energy configuration system may determine an energy plan for a vehicle based on energy requirements about a supply of electricity to which the vehicle is capable of dispensing electrical charge, wherein the energy plan includes plans for dispensing electrical charge from the vehicle to the supply and/or for withdrawing electrical charge from the supply. The energy configuration system may then generate movement instructions for the vehicle based on the energy plan.

### TECHNICAL FIELD

The disclosure relates generally to vehicles, and in particular to electric/hybrid vehicles that have the ability to store electricity on-board the vehicle (e.g., in a battery) and the ability to withdraw electricity from or dispense electricity to an external electrical supply (e.g., to/from an electrical grid via a charging station).

### BACKGROUND

In recent years, consumers and manufacturers have been moving from combustion engine vehicles to electric vehicles or hybrid vehicles. Electric and/or hybrid vehicles often include some form of energy storage, such as a battery, that provides the vehicle a source of energy for operating the vehicle. In the case of a hybrid vehicle, the vehicle itself may generate/renew energy for the energy storage by operating an internal combustion engine. Additionally, the vehicle may connect to a charging station in order to recharge the energy storage. In the case of a fully electric vehicle, the vehicle's energy storage must either be replaced (e.g., a depleted battery exchanged for a charged one) or the energy storage must be recharged by connecting the vehicle to a charging station, where energy may be withdrawn from the energy grid to recharge the battery.

At the same time, energy grids to which an electric and/or hybrid vehicle may connect are not necessarily consistent in terms of the grid's available supply of electrical power and actual demands for electrical power. For example, the grid may be supplied by alternative energy sources such as wind and solar that may be weather dependent, leading to potential shortfalls in the grid when demand becomes higher than the currently available supply (e.g., when wind speeds and/or solar light levels are low). Or, if the weather is particularly beneficial to power-generation (e.g., high winds and/or favorable solar light levels), there may be an excess of electrical supply in the grid, especially when demand is lower than the currently available supply.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, various exemplary aspects of the disclosure are described with reference to the following drawings, in which:

FIG. 1 shows an example of an energy configuration system that may generate an energy plan for a vehicle that takes into account requirements of an energy supply and generates movement instructions for a vehicle;

FIG. 2 shows an exemplary schematic drawing of a device for generating an energy plan of a vehicle that takes into account requirements of an energy supply and generates movement instructions for the vehicle; and

FIG. 3 depicts a schematic flow diagram of an exemplary method for generating an energy plan of a vehicle that takes into account requirements of an energy supply and generates movement instructions for the vehicle.

### DESCRIPTION

The following detailed description refers to the accompanying drawings that show, by way of illustration, exemplary details and features.

The word “exemplary” is used herein to mean “serving as an example, instance, or illustration.” Any aspect or design described herein as “exemplary” is not necessarily to be construed as preferred or advantageous over other aspects or designs.

Throughout the drawings, it should be noted that like reference numbers are used to depict the same or similar elements, features, and structures, unless otherwise noted.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

The words “plural” and “multiple” in the description and in the claims expressly refer to a quantity greater than one. Accordingly, any phrases explicitly invoking the aforementioned words (e.g., “plural [elements]”, “multiple [elements]”) referring to a quantity of elements expressly refers to more than one of the said elements. For instance, the phrase “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., in the description and in the claims, if any, refer to a quantity equal to or greater than one, i.e., one or more. The terms “proper subset”, “reduced subset”, and “lesser subset” refer to a subset of a set that is not equal to the set, illustratively, referring to a subset of a set that contains less elements than the set.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in the form of a pointer. The term “data”, however, is not limited to the aforementioned examples and may take various forms and represent any information as understood in the art.

The terms “processor” or “controller” as, for example, used herein may be understood as any kind of technological entity (e.g., hardware, software, and/or a combination of both) that allows handling of data. The data may be handled according to one or more specific functions executed by the processor or controller. Further, a processor or controller as used herein may be understood as any kind of circuit, e.g., any kind of analog or digital circuit. A processor or a controller may thus be or include an analog circuit, digital circuit, mixed-signal circuit, software, firmware, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor, controller, or logic circuit. It is understood that any two (or more) of the processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

As used herein, “memory” is understood as a computer-readable medium (e.g., a non-transitory computer-readable medium) in which data or information can be stored for retrieval. References to “memory” included herein may thus be understood as referring to volatile or non-volatile memory, including random access memory (RAM), read-only memory (ROM), flash memory, solid-state storage, magnetic tape, hard disk drive, optical drive, 3D XPoint™, among others, or any combination thereof. Registers, shift registers, processor registers, data buffers, among others, are also embraced herein by the term memory. The term “software” refers to any type of executable instruction, including firmware.

Unless explicitly specified, the term “transmit” encompasses both direct (point-to-point) and indirect transmission (via one or more intermediary points). Similarly, the term “receive” encompasses both direct and indirect reception. Furthermore, the terms “transmit,” “receive,” “communicate,” and other similar terms encompass both physical transmission (e.g., the transmission of radio signals) and logical transmission (e.g., the transmission of digital data over a logical software-level connection). For example, a processor or controller may transmit or receive data over a software-level connection with another processor or controller in the form of radio signals, where the physical transmission and reception is handled by radio-layer components such as RF transceivers and antennas, and the logical transmission and reception over the software-level connection is performed by the processors or controllers. The term “communicate” encompasses one or both of transmitting and receiving, i.e., unidirectional or bidirectional communication in one or both of the incoming and outgoing directions. The term “calculate” encompasses both “direct” calculations via a mathematical expression/formula/relationship and ‘indirect’ calculations via lookup or hash tables and other array indexing or searching operations.

A “vehicle” may be understood to include any type of driven object. By way of example, a vehicle may be a driven object with a combustion engine, a reaction engine, an electrically driven object, a hybrid driven object, or a combination thereof. A vehicle may be or may include an automobile, a bus, a mini bus, a van, a truck, a mobile home, a vehicle trailer, a motorcycle, a bicycle, a tricycle, a train locomotive, a train wagon, a moving robot, a personal transporter, a boat, a ship, a submersible, a submarine, a drone, an aircraft, or a rocket, among others. As used herein, references to an “electric vehicle,” “EV,” and “hybrid vehicle” include any type of vehicle with an energy storage (e.g., a battery) that is capable of operating (e.g. propelling) the vehicle, irrespective of other sources of energy, if any, from which the vehicle may be alternatively or additionally operated (e.g., sources such as a combustion engine, solar panels, etc.).

The term “autonomous vehicle” may describe a vehicle capable of implementing at least one vehicle maneuver without driver input. A vehicle maneuver may describe or include a change in one or more of steering, braking, acceleration/deceleration, etc. of the vehicle. A vehicle may be described as autonomous even in case the vehicle is not fully automatic (for example, fully operational with driver input or without driver input). Autonomous vehicles may include those vehicles that can operate under driver control during certain time periods and without driver control during other time periods. Autonomous vehicles may also include vehicles that control only some aspects of vehicle navigation, such as steering (e.g., to maintain a vehicle course between vehicle lane constraints) or some steering operations under certain circumstances, but may leave other aspects of vehicle navigation to the driver during other circumstances (e.g., braking under certain circumstances). Autonomous vehicles may also include vehicles that share the control of one or more aspects of vehicle maneuver implementation/planning under certain circumstances (e.g., hands-on, such as responsive to a driver input) and vehicles that control one or more aspects of vehicle maneuvering under certain circumstances (e.g., hands-off, such as independent of driver input). Autonomous vehicles may also include vehicles that control one or more aspects of vehicle navigation under certain circumstances, such as under certain environmental conditions (e.g., spatial areas, roadway conditions). In some aspects, autonomous vehicles may handle some or all aspects of braking, speed control, velocity control, and/or steering of the vehicle.

An autonomous vehicle may include those vehicles that can operate without a driver. The level of autonomy of a vehicle may be described or determined by the Society of Automotive Engineers (SAE) level of the vehicle (e.g., as defined by the SAE, for example in SAE J3016 2018: Taxonomy and definitions for terms related to driving automation systems for on road motor vehicles) or by other relevant professional organizations. The SAE level may have a value ranging from a minimum level, e.g. level 0 (illustratively, substantially no driving automation), to a maximum level, e.g. level 5 (illustratively, full driving automation).

As noted above, hybrid and electric vehicles may connect to charging stations in order to replenish their energy storage (e.g., one or more batteries), where energy may be withdrawn from the energy grid through the charging station to replenish the energy storage (e.g., recharge the battery). In addition, charging stations may be bidirectional, meaning that energy could be offloaded (e.g., dispensed) to the energy grid from the energy storage of the electric vehicle. As should be appreciated, there is usually a monetary cost associated with transferring energy, where the costs may fluctuate depending on supply and demand. For example, high demand on the energy grid with low supply may mean correspondingly high costs for the vehicle to withdraw energy from the grid. At the same time, if energy is dispensed from the vehicle to the grid when there is high demand and low supply, this may result in a high selling price for the vehicle owner. In some cases, for example if the grid is producing far more energy than current demands and it is too expensive to reduce the grid's energy production, the “cost” for withdrawing energy may become negative, meaning that the grid may pay for a withdrawal of energy from the grid in order to avoid having to reduce the grid's energy production. A similar situation may occur when the grid requires additional storage for offloading energy from the grid in order to stabilize the grid, where the grid may offer premiums to consumers for withdrawing energy from the grid. Thus, depending on the energy requirements of the grid from the perspective of both supply and demand, there may be an associated cost or windfall associated with energy transfer to/from the grid.

Conventional electric vehicles do not take into account such grid information when operating the vehicle or planning routes to a destination. Instead, electric vehicles generally optimize power consumption to ensure that the vehicle uses a minimum amount of electricity to reach a destination (e.g., an energy-efficient route, an energy-efficient operating mode of the vehicle, etc.). Or, the electric vehicle may select a route based on the location/availability of compatible charging stations. However, neither of these methods determine operating parameters for the vehicle or plan routes for the vehicle based on the current/predicted energy requirements of the electrical power grid. In addition, while some electrical grids may have the capability to receive information about the current battery capacity of vehicles currently connected to the grid (e.g., batteries that are currently charging from/discharging to the grid), this information is used only to ensure the battery is charged to a target battery capacity (e.g., 70%-90% of capacity) and provides very small range within which the grid may adapt its supply/receipt of energy to/from the battery. In addition, battery information from the vehicle is not available when the vehicle is disconnected from the grid.

In contrast to conventional systems, the energy configuration system disclosed below uses current/predicted energy requirements of the grid in order to determine operating parameters for the vehicle and/or plan routes for the vehicle, allowing the vehicle to include current/predicted energy costs as part of its planning system and allowing the grid to send requests to vehicles in hopes of matching its current/predicted supply of energy to its current/predicted demand for energy. The energy configuration system disclosed in more detail below may use the grid's information about current and forecasted energy availability in the grid as well as the associated prices to adapt the vehicle's driving behavior, route planning, and charging/de-charging planning. The disclosed energy configuration system may also allow for optimizing charging costs (or windfalls) and may also balance under-/over-supply/demand on the grid by adapting the vehicle's behavior, routes, and charge planning. With an interface between the grid's requirements and the vehicle's plans, electric vehicles may become an important part of the energy grid's infrastructure, allow a more stable supply of energy and allowing vehicle owners to reduce energy costs or earn profits when connecting to the grid.

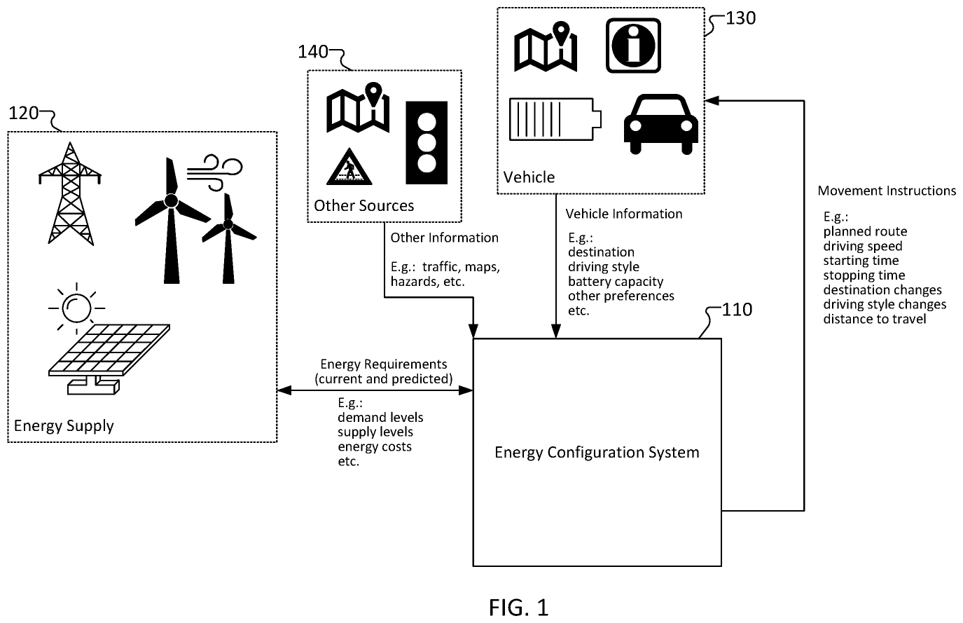

FIG. 1 shows an energy configuration system 110 that interfaces with the energy supply 120 (e.g., an electric grid that supplies electricity and may be sourced by windmills, solar panels, conventional power plants, and/or other energy sources) in order to obtain energy supply information about the energy supply 120, such as energy requirements (e.g., demand levels, supply levels, energy costs, etc.) of the energy supply 120. The energy configuration system 110 may also interface with vehicle 130 to obtain information about vehicle 130, such as operational parameters, destination information, preferences, etc. The energy configuration system 110 may also receive information from other sources 140 (such as map information, traffic information, hazard information, etc.). The energy configuration system 110 may then use this information to generate an energy plan for vehicle 130 (e.g., a time, location, amount, plan, etc. for vehicle 130 to withdraw electrical energy from the energy supply 120 or for vehicle 130 to dispense electrical energy to the energy supply 120). Based on the energy plan, the energy configuration system 110 may then generate movement instructions for vehicle 130 that helps realize the energy plan.

The energy configuration system 110 may perform any number of energy-related functions, including battery storage optimization, route planning optimization, and estimation of energy production and consumption. The energy configuration system 110 may also manage a plurality of vehicles that may be part of a coordinated services network (e.g., vehicles operated as a fleet, such as a taxi service or a car sharing service). Thus, references herein to a vehicle (e.g., vehicle 130) should be understood to also encompass a plurality of vehicles.

With respect to battery storage optimization functions, for example, the battery of vehicle 130 may be understood as an energy storage resource for the energy supply 120, where vehicle 130 may optimize the usage of its battery (e.g., determine an energy plan for vehicle 130) in conjunction with the energy requirements of the energy supply 120 and in conjunction with minimizing costs (or maximizing windfalls) or other predefined goals/priorities of vehicle 130. For example, vehicle 130 may prioritize financial benefits, where the goal is to minimize costs (e.g., costs associated with withdrawing electricity from the energy supply 120) and maximize windfalls (e.g., profits received for dispensing electricity into the energy supply 120). This functionality provides more than simply planning a route based on locations of charging stations. Rather, the battery storage optimization may be based on actual and predicted requirements of the energy supply 120 over time, which may include, for example, expected/predicted demand levels at a particular time in the future, expected/predicted supply levels at a particular time in the future, expected/predicted energy windfalls/costs at a particular time in the future, etc. This allows for generating an energy plan that may take into account the requirements of the energy supply 120. In this manner, the use of vehicle 130 may be optimized with respect to the benefit it may offer to the energy supply 120 (e.g., in terms of offloading energy from vehicle 130 to energy supply 120 or vice versa).

For example, when the user of the car wants to drive to a target destination, a conventional route planner typically considers time to destination, user preferences, energy consumption, locations of charging stations, etc. The conventional route planner may thus optimize time to the target destination by finding the fastest route that meets the user preferences, including locating a charging station along the route to recharge the battery so there is sufficient energy to arrive at the destination. By contrast, the energy configuration system 110 may take into account the ability of vehicle 130 to act as a storage unit (to offload energy from energy supply 120) or as a source of energy (e.g., to supply power to the energy supply 120). When taking into account the storage/source capacity of vehicle 130 and the requirements of energy supply 120, such as energy prices, the energy configuration system 110 may make improved decisions for how, when, and in what manner the battery of the vehicle 130 is used.

For example, if energy supply 120 is currently overproducing energy (e.g., such that the energy supply 120 needs to off-load energy, where the “cost” to a vehicle owner for withdrawing energy may be negative), the energy configuration system 110 might use a route that provides a faster arrival time to the target destination in order to connect the battery of vehicle 130 to the energy supply 120 sooner. As another example, the energy configuration system 110 might use an energy inefficient route so that the vehicle 130 has a higher level of battery storage capacity (e.g., an empty battery) at the destination. Even if the route consumes more energy to arrive at the target destination, this may be more profitable from the perspective of vehicle 130, where the energy supply 120 may pay money to withdraw energy from the supply. Or, if energy demand of the energy supply 120 is high such that it pays high prices for receiving energy from external sources such as the battery of vehicle 130, it may be more profitable from the perspective of vehicle 130 to adjust the route such that vehicle 130 may offload energy from its battery to the energy supply 120 as soon as possible.

The energy configuration system 110 may use an optimization algorithm that takes into account any number of factors for maximizing the total benefit, which may be the sum of the costs for withdrawing energy from the grid (e.g., withdrawing energy to vehicle 130 from energy supply 120) and the costs for dispensing energy to the grid (e.g., supplying energy from vehicle 130 to energy supply 120). The costs for withdrawing energy from the grid may be the current price (C_{withdraw}) per unit of energy at the time withdrawn (t), thus the price for charging (C_{withdraw, t}) multiplied by the amount of energy withdrawn at that time (E_{withdrawn, t}). The costs for supplying energy to the grid may be the current price (C_{supply}) at the time supplied, thus the price for dispensing to the grid (C_{supply, t}) multiplied by the amount of energy dispensed to the grid at that time (E_{supplied, t}). As should be understood, the price per unit of energy may depend on market factors and the particular requirements of the energy supplier, while the amount of energy withdrawn/dispensed may depend on the driving profile, battery capacity, route, etc. of vehicle 130. The configuration system 110 may solve an optimization problem (e.g., a non-linear optimization problem) that, for example, maximizes a function (ƒ) that may depend on a number (n) of parameters (x) that may be subject to any number (m) of constraints (g):

$$maximize f ( {x}_{1} , {x}_{2} , {x}_{3} , ... , {x}_{n} ) ,$$

$$subject to m constraints {g}_{j} ( {x}_{1} , {x}_{2} , {x}_{3} , ... , {x}_{n} ) \leq {b}_{j} for j ∈ \{ 1 , ... , m \}$$

The various parameters (x) may include any number (n) of factors, including but not limited to, as examples, the price (current/forecasted) to withdraw energy from the energy supply, the price (current/forecasted) to dispense energy to the energy supply, the amount of energy (current/forecasted) to be withdrawn from the energy supply, the amount of energy (current/forecasted) to be dispensed to the energy supply, the route, the driving profile of the vehicle, etc. The optimization problem may also be subject to any number (m) of constraints (g), including but not limited to, as examples, a predefined destination of the vehicle, a predefined driving profile of the vehicle, a maximum duration for the vehicle to travel to a predefined destination, a maximum energy cost for the vehicle to travel to the predefined destination, a latest arrival time for the vehicle to arrive at the predefined destination, an earliest arrival time for the vehicle to arrive at the predefined destination, a maximum energy consumption of the vehicle to arrive at the predefined destination, a minimum energy consumption of the vehicle to arrive at the predefined destination, a maximum battery level to which a storage battery of the vehicle may be filled, a minimum battery level to which the storage battery may be depleted, a total capacity of the storage battery, etc.

As should also be understood, information provided to the energy configuration system 110 (e.g., from vehicle 130 or from other sources 140) may also include information about private sources of energy production/consumption from which vehicle 130 may be supplied energy or to which vehicle 130 may dispense energy. For example, an owner of vehicle 130 may have solar panels at home for supplying electricity to the home and for charging the batteries of vehicle 130. This external source of energy may be one of the various parameters and/or constraints discussed above with respect to the optimization problem, where for example, the private source of energy production/consumption and the planned usage of the private source of energy (e.g., planned activities that may consume energy from the private source of energy such as running a washing machine, dryer, dishwasher, etc.) may be taken into account as part of the optimization problem.

By solving the optimization problem, energy configuration system 110 may determine an optimal route, determine optimum driving profile parameters, and/or determine specific movement instructions for vehicle 130 (e.g., to follow a planned route, to set a driving speed of the vehicle, to set a stopping time for the vehicle, to set a destination (e.g., an intermediate stop) for the vehicle, to set a driving style of the vehicle, to set a distance for the vehicle to travel, etc.). By following the movement instructions, the vehicle 130 may be able to realize the optimization to, for example, reach the target destination and supply/withdraw energy to/from the energy supply 120 in a way that meets the requirements of the energy supply 120 and/or provides the vehicle 130 with improved energy-related costs (or windfalls).

As noted above, part of the optimization may include route planning optimization, where the energy configuration system 110 may optimize the actual route and driving style of the vehicle. For example, this may include the schedule along the route, when to take a trip, a destination (or intermediate destination) for the vehicle, etc. For example, the vehicle 130 (e.g., a user or owner of vehicle 130) may input (e.g., through a graphical user interface), a set of planned trips along with constraints related to those trips (e.g., earliest/latest starting times, dates by which the trip must be completed, etc.). Then, as an output of the optimization problem, the energy configuration system 110 may determine an optimal date/time for the trip together with a route that provides the optimal power consumption to arrive at the destination with the desired battery capacity. The route may include intermediate stops at, for example, charging stations, that allows the vehicle 130 to charge/discharge its battery at optimal times related to the requirements of the energy supply 120 and/or provides the vehicle 130 with improved energy-related costs (or windfalls). These types of route planning optimization features may be particularly helpful to vehicles that are collectively managed as part of a fleet (e.g., a taxi service, a car-sharing service, a fleet of delivery trucks, etc.), where vehicles may be staged at different locations, used at different times, and may have different battery capacities. For a logistic fleet of electrical trucks, for example, such trucks may have high capacity batteries such that, even for small changes in the price of energy, there may be significant differences in the optimization problem and the overall energy-related costs (or windfalls) for the vehicles.

In addition, with respect to a group of vehicles that may be centrally managed as a fleet of vehicles, the fleet configuration may be adapted based on the requirements of the energy supply 120. For example, the energy supply 120 may have or anticipate a higher demand in energy than it can supply and therefore may be in need of additional (e.g., external) sources of energy. The fleet may learn of this additional energy requirement (e.g., in a notification from the energy supply 120 or by monitoring the status of the energy supply 120), and the energy configuration system 110 may optimize utilization of its fleet in a way that vehicles in the fleet are able to supply additional power to the energy supply 120 at the requested/optimum times. Similarly, energy configuration system 110 may also adjust the routing of the vehicles in the fleet to respond to the requirements of the energy supply 120. For example, a fleet of taxis might change the way they service a given geographical area by, for example, instead of the vehicles in the fleet driving clockwise, the vehicles in the fleet may drive counter-clockwise to optimize locations where energy may be dispensed from fleet vehicles to the energy supply 120. As should be appreciated, these requirements of the energy supply 120 and/or the configuration of the fleet may also include a spatial-temporal component. For example, the energy configuration system 110 may monitor the status of the energy supply 120 in particular geographic areas at particular times and adjust the location of individual vehicles in the fleet to accommodate the energy requirements of the energy supply 120 for those particular areas at that particular time. For example, the fleet may reposition certain vehicles to park at charging stations in an area of and at a time of high energy demand.

As should be understood, the energy configuration system 110 may include a memory for storing any of the information discussed above, including, for example, the optimization problem/function, the parameters of the optimization problem/function, the constraints on the optimization problem/function, the information received from the energy supply 120, the information received from the vehicle 130, the information received from other sources 140, the movement instructions, etc. As should also be understood, the energy configuration system 110 may include a transmitter and/or receiver (e.g., a transceiver) for communicating (e.g., wirelessly) with the energy supply 120, the other sources 140, and/or the vehicle 130.

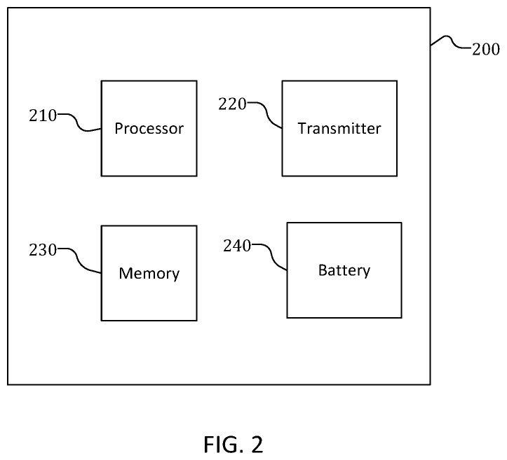

FIG. 2 is a schematic drawing illustrating a device 200 for generating an energy plan of a vehicle that takes into account requirements of an energy supply and generates movement instructions for the vehicle. The device 200 may include any of the features of the energy configuration systems described above (e.g., energy configuration system 110 discussed above with respect to FIG. 1). The energy configuration system of FIG. 2 may be implemented as a device, a method, and/or a computer readable medium that, when executed, performs the features of the energy configuration systems described above. It should be understood that device 200 is only an example, and other configurations may be possible that include, for example, different components or additional components.

Device 200 includes a processor 210. In addition to or in combination with any of the features described in the following paragraphs, processor 210 is configured to determine an energy plan for the vehicle based on energy requirements about a supply of electricity to which the vehicle is capable of dispensing electrical charge, wherein the energy plan includes plans for dispensing electrical charge from the vehicle to the supply. In addition to or in combination with any of the features described in the following paragraphs, processor 210 is also configured to generate movement instructions for the vehicle based on the energy plan.

Furthermore, in addition to or in combination with any of the features described in this or the preceding paragraph with respect to device 200, the energy requirements may include a cost associated with withdrawing electrical charge from the supply or with dispensing electrical charge to the supply. Furthermore, in addition to or in combination with any of the features described in this or the preceding paragraph, the cost may include a forecasted cost associated with withdrawing electrical charge from the supply at a future time or with dispensing electrical charge to the supply at the future time. Furthermore, in addition to or in combination with any of the features described in this or the preceding paragraph, the energy requirements may include an available amount of energy offered from the supply or demanded by the supply. Furthermore, in addition to or in combination with any of the features described in this or the preceding paragraph, the available amount of energy may include a forecasted available amount of energy offered from the supply at a future time or demanded by the supply at the future time. Furthermore, in addition to or in combination with any of the features described in this or the preceding paragraph, the energy plan may include a time or location for withdrawing electrical charge from or dispensing electrical charge to the supply.

Furthermore, in addition to or in combination with any of the features described in this or the preceding two paragraphs with respect to device 200, the vehicle may be configured to withdraw electrical charge from or dispense electrical charge to the supply through a charging station. Furthermore, in addition to or in combination with any of the features described in this or the preceding two paragraphs, the plans for dispensing electrical charge to (or withdrawing electrical charge from) the supply may include at least one of a time of the dispensing (or withdrawing), a location of the dispensing (or withdrawing), and an amount of electricity associated with the dispensing (or withdrawing). Furthermore, in addition to or in combination with any of the features described in this or the preceding two paragraphs, the movement instructions may include at least one of a planned route for the vehicle, a driving speed of the vehicle, a stopping time for the vehicle, a destination for the vehicle, a driving style of the vehicle, and a distance for the vehicle to travel.

Furthermore, in addition to or in combination with any of the features described in this or the preceding three paragraphs with respect to device 200, the energy plan may be further based on additional parameters including one or more of a predefined destination of the vehicle, a predefined driving profile of the vehicle, a maximum duration for the vehicle to travel to the predefined destination, a maximum energy cost for the vehicle to travel to the predefined destination, a latest arrival time for the vehicle to arrive at the predefined destination, an earliest arrival time for the vehicle to arrive at the predefined destination, a maximum energy consumption of the vehicle to arrive at the predefined destination, a minimum energy consumption of the vehicle to arrive at the predefined destination, a maximum battery level to which a storage battery of the vehicle may be filled, and a minimum battery level to which the storage battery may be depleted. Furthermore, in addition to or in combination with any of the features described in this or the preceding three paragraphs, processor 210 configured to determine the energy plan may include processor 210 configured to prioritize the plans based on the additional parameters and according to a predefined criterion associated with the plans and additional parameters.

Furthermore, in addition to or in combination with any of the features described in this or the preceding four paragraphs with respect to device 200, the supply of electricity may include a power grid to which the vehicle may connect in order to discharge an electrical storage of the vehicle or to charge the electrical storage of the vehicle. Furthermore, in addition to or in combination with any of the features described in this or the preceding four paragraphs, the electrical storage may include a rechargeable battery. Furthermore, in addition to or in combination with any of the features described in this or the preceding four paragraphs, device 200 may further include a battery 240 vehicle, wherein battery 240 is configurable to dispense electrical charge from the battery to the supply or withdraw electrical charge from the supply to the battery. Furthermore, in addition to or in combination with any of the features described in this or the preceding four paragraphs, device 200 may further include a memory 230 configured to store at least one of the movement instructions, the energy plan, and a function that relates the energy plan to the movement instructions. Furthermore, in addition to or in combination with any of the features described in this or the preceding four paragraphs, device 200 may further include a wireless transceiver 220 configured to receive the energy requirements (e.g., from a provider of the supply of electricity) and/or to transmit the movement instructions to the vehicle. Furthermore, in addition to or in combination with any of the features described in this or the preceding four paragraphs, the energy requirements may include a request from the supply for the vehicle to connect to the supply.

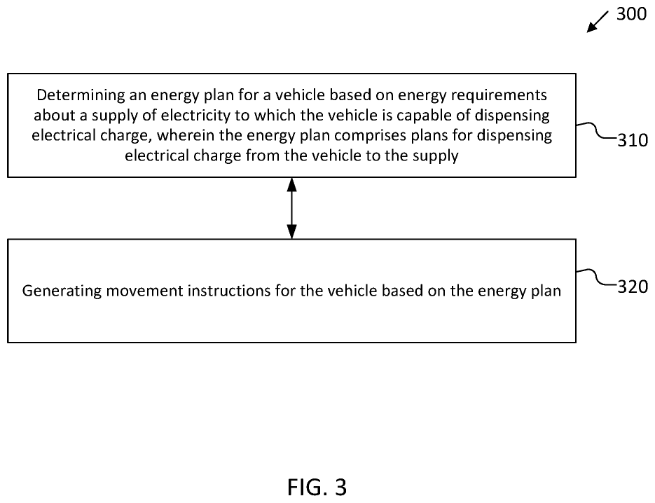

FIG. 3 depicts a schematic flow diagram of a method 300 for generating an energy plan of a vehicle that takes into account requirements of an energy supply and generates movement instructions for the vehicle. Method 300 may implement any of the features of the energy configuration systems described above, including but not limited to energy configuration system 110 discussed above with respect to FIG. 1 and/or device 200 discussed above with respect to FIG. 2.

Method 300 includes, in 310, determining an energy plan for a vehicle based on energy requirements about a supply of electricity to which the vehicle is capable of dispensing electrical charge, wherein the energy plan comprises plans for dispensing electrical charge from the vehicle to the supply. Method 300 also includes, in 320, generating movement instructions for the vehicle based on the energy plan.

In the following, various examples are provided that may include one or more features of the energy configuration systems described above, for example with reference to FIGS. 1-3. It may be intended that aspects described in relation to the devices may apply also to the described method(s), and vice versa.

Example 1 is a device for configuring a vehicle, the device including a processor configured to determine an energy plan for the vehicle based on energy requirements about a supply of electricity to which the vehicle is capable of dispensing electrical charge, wherein the energy plan includes plans for dispensing electrical charge from the vehicle to the supply. The processor is also configured to generate movement instructions for the vehicle based on the energy plan.

Example 2 is the device of example 1, wherein the energy requirements include a cost associated with withdrawing electrical charge from the supply or with dispensing electrical charge to the supply.

Example 3 is the device of example 2, wherein the cost includes a forecasted cost associated with withdrawing electrical charge from the supply at a future time or with dispensing electrical charge to the supply at the future time.

Example 4 is the device of any one of examples 1 to 3, wherein the energy requirements include an available amount of energy offered from the supply or demanded by the supply.

Example 5 is the device of example 4, wherein the available amount of energy includes a forecasted available amount of energy offered from the supply at a future time or demanded by the supply at the future time.

Example 6 is the device of any one of examples 1 to 5, wherein the energy plan includes a time or location for withdrawing electrical charge from or dispensing electrical charge to the supply.

Example 7 is the device of any one of examples 1 to 6, wherein vehicle is configured to withdraw electrical charge from or dispense electrical charge to the supply through a charging station.

Example 8 is the device of any one of examples 1 to 7, wherein the energy plan further comprises plans for withdrawing electrical charge from the supply.

Example 9 is the device of any one of examples 1 to 8, wherein the plans for dispensing electrical charge to (or withdrawing electrical charge from) the supply include at least one of a time of the dispensing (or withdrawing), a location of the dispensing (or withdrawing), and an amount of electricity associated with the dispensing (or withdrawing).

Example 10 is the device of any one of examples 1 to 9, wherein the movement instructions include at least one of a planned route for the vehicle, a driving speed of the vehicle, a stopping time for the vehicle, a destination for the vehicle, a driving style of the vehicle, and a distance for the vehicle to travel.

Example 11 is the device of any one of examples 1 to 10, wherein the energy plan is further based on additional parameters including one or more of a predefined destination of the vehicle, a predefined driving profile of the vehicle, a maximum duration for the vehicle to travel to the predefined destination, a maximum energy cost for the vehicle to travel to the predefined destination, a latest arrival time for the vehicle to arrive at the predefined destination, an earliest arrival time for the vehicle to arrive at the predefined destination, a maximum energy consumption of the vehicle to arrive at the predefined destination, a minimum energy consumption of the vehicle to arrive at the predefined destination, a maximum battery level to which a storage battery of the vehicle may be filled, and a minimum battery level to which the storage battery may be depleted.

Example 12 is the device of example 11, wherein the processor configured to determine the energy plan includes the processor configured to prioritize the plans based on the additional parameters and according to a predefined criterion associated with the plans and additional parameters.

Example 13 is the device of any one of examples 1 to 12, wherein the supply of electricity includes a power grid to which the vehicle may connect in order to discharge an electrical storage of the vehicle or to charge the electrical storage of the vehicle.

Example 14 is the device of example 13, wherein the electrical storage includes a rechargeable battery.

Example 15 is the device of any one of examples 1 to 14, the device further including a battery of the vehicle, wherein the battery is configurable to dispense electrical charge from the battery to the supply or withdraw electrical charge from the supply to the battery.

Example 16 is the device of any one of examples 1 to 15, the device further including a memory configured to store at least one of the movement instructions, the energy plan, and a function that relates the energy plan to the movement instructions.

Example 17 is the device of any one of examples 1 to 16, the device further including a wireless transceiver configured to receive the energy requirements (e.g., from a provider of the supply of electricity) or to transmit the movement instructions to the vehicle.

Example 18 is the device of any one of examples 1 to 17, wherein the energy requirements include a request from the supply for the vehicle to connect to the supply.

Example 19 is a method for configuring a vehicle, the method includes determining an energy plan for the vehicle based on energy requirements about a supply of electricity to which the vehicle is capable of dispensing electrical charge, wherein the energy plan includes plans for dispensing electrical charge from the vehicle to the supply. The method also includes generating movement instructions for the vehicle based on the energy plan.

Example 20 is the method of example 19, wherein the energy requirements include a cost associated with withdrawing electrical charge from the supply or with dispensing electrical charge to the supply.

Example 21 is the method of example 20, wherein the cost includes a forecasted cost associated with withdrawing electrical charge from the supply at a future time or with dispensing electrical charge to the supply at the future time.

Example 22 is the method of any one of examples 19 to 21, wherein the energy requirements include an available amount of energy offered from the supply or demanded by the supply.

Example 23 is the method of example 22, wherein the available amount of energy includes a forecasted available amount of energy offered from the supply at a future time or demanded by the supply at the future time.

Example 24 is the method of any one of examples 19 to 23, wherein the energy plan includes a time or location for withdrawing electrical charge from or dispensing electrical charge to the supply.

Example 25 is the method of any one of examples 19 to 24, wherein vehicle is configured to withdraw electrical charge from or dispense electrical charge to the supply through a charging station.

Example 26 is the method of any one of examples 19 to 25, wherein the energy plan further comprises plans for withdrawing electrical charge from the supply.

Example 27 is the method of any one of examples 19 to 26, wherein the plans for dispensing electrical charge to (or withdrawing electrical charge from) the supply include at least one of a time of the dispensing (or withdrawing), a location of the dispensing (or withdrawing), and an amount of electricity associated with the dispensing (or withdrawing).

Example 28 is the method of any one of examples 19 to 27, wherein the movement instructions include at least one of a planned route for the vehicle, a driving speed of the vehicle, a stopping time for the vehicle, a destination for the vehicle, a driving style of the vehicle, and a distance for the vehicle to travel.

Example 29 is the method of any one of examples 19 to 28, wherein the energy plan is further based on additional parameters including one or more of a predefined destination of the vehicle, a predefined driving profile of the vehicle, a maximum duration for the vehicle to travel to the predefined destination, a maximum energy cost for the vehicle to travel to the predefined destination, a latest arrival time for the vehicle to arrive at the predefined destination, an earliest arrival time for the vehicle to arrive at the predefined destination, a maximum energy consumption of the vehicle to arrive at the predefined destination, a minimum energy consumption of the vehicle to arrive at the predefined destination, a maximum battery level to which a storage battery of the vehicle may be filled, and a minimum battery level to which the storage battery may be depleted.

Example 30 is the method of example 29, wherein the means for determining the energy plan includes a means for prioritizing the plans based on the additional parameters and according to a predefined criterion associated with the plans and additional parameters.

Example 31 is the method of any one of examples 19 to 30, wherein the supply of electricity includes a power grid to which the vehicle may connect in order to discharge an electrical storage of the vehicle or to charge the electrical storage of the vehicle.

Example 32 is the method of example 31, wherein the electrical storage includes a rechargeable battery.

Example 33 is the method of any one of examples 19 to 32, the apparatus further including a means for dispensing electrical charge from a battery of the vehicle to the supply or a means for withdrawing electrical charge from the supply to the battery.

Example 34 is the method of any one of examples 19 to 33, the method further including storing (e.g., in a memory) at least one of the movement instructions, the energy plan, and a function that relates the energy plan to the movement instructions.

Example 35 is the method of any one of examples 19 to 34, the method further including receiving (e.g., via a wireless transceiver) the energy requirements (e.g., from a provider of the supply of electricity) or transmitting (e.g., via a wireless transceiver) the movement instructions to the vehicle.

Example 36 is the method of any one of examples 19 to 35, wherein the energy requirements include a request from the supply for the vehicle to connect to the supply.

Example 37 is an apparatus for configuring a vehicle, the apparatus includes a means for determining an energy plan for the vehicle based on energy requirements about a supply of electricity to which the vehicle is capable of dispensing electrical charge, wherein the energy plan includes plans for dispensing electrical charge from the vehicle to the supply. The apparatus also includes a means for generating movement instructions for the vehicle based on the energy plan.

Example 38 is the apparatus of example 37, wherein the energy requirements include a cost associated with withdrawing electrical charge from the supply or with dispensing electrical charge to the supply.

Example 39 is the apparatus of example 38, wherein the cost includes a forecasted cost associated with withdrawing electrical charge from the supply at a future time or with dispensing electrical charge to the supply at the future time.

Example 40 is the apparatus of any one of examples 37 to 39, wherein the energy requirements include an available amount of energy offered from the supply or demanded by the supply.

Example 41 is the apparatus of example 40, wherein the available amount of energy includes a forecasted available amount of energy offered from the supply at a future time or demanded by the supply at the future time.

Example 42 is the apparatus of any one of examples 37 to 41, wherein the energy plan includes a time or location for withdrawing electrical charge from or dispensing electrical charge to the supply.

Example 43 is the apparatus of any one of examples 37 to 42, wherein vehicle is configured to withdraw electrical charge from or dispense electrical charge to the supply through a charging station.

Example 44 is the apparatus of any one of examples 37 to 43, wherein the energy plan further comprises plans for withdrawing electrical charge from the supply.

Example 45 is the apparatus of any one of examples 37 to 44, wherein the plans for dispensing electrical charge to (or withdrawing electrical charge from) the supply include at least one of a time of the dispensing (or withdrawing), a location of the dispensing (or withdrawing), and an amount of electricity associated with the dispensing (or withdrawing).

Example 46 is the apparatus of any one of examples 37 to 45, wherein the movement instructions include at least one of a planned route for the vehicle, a driving speed of the vehicle, a stopping time for the vehicle, a destination for the vehicle, a driving style of the vehicle, and a distance for the vehicle to travel.

Example 47 is the apparatus of any one of examples 37 to 46, wherein the energy plan is further based on additional parameters including one or more of a predefined destination of the vehicle, a predefined driving profile of the vehicle, a maximum duration for the vehicle to travel to the predefined destination, a maximum energy cost for the vehicle to travel to the predefined destination, a latest arrival time for the vehicle to arrive at the predefined destination, an earliest arrival time for the vehicle to arrive at the predefined destination, a maximum energy consumption of the vehicle to arrive at the predefined destination, a minimum energy consumption of the vehicle to arrive at the predefined destination, a maximum battery level to which a storage battery of the vehicle may be filled, and a minimum battery level to which the storage battery may be depleted.

Example 48 is the apparatus of example 47, wherein determining the energy plan includes prioritizing the plans based on the additional parameters and according to a predefined criterion associated with the plans and additional parameters.

Example 49 is the apparatus of any one of examples 37 to 48, wherein the supply of electricity includes a power grid to which the vehicle may connect in order to discharge an electrical storage of the vehicle or to charge the electrical storage of the vehicle.

Example 50 is the apparatus of example 49, wherein the electrical storage includes a rechargeable battery.

Example 51 is the apparatus of any one of examples 37 to 50, the apparatus further including a means for dispensing electrical charge from a battery of the vehicle to the supply or a means for withdrawing electrical charge from the supply to the battery.

Example 52 is the apparatus of any one of examples 37 to 51, the apparatus further including a means for storing (e.g., in a memory) at least one of the movement instructions, the energy plan, and a function that relates the energy plan to the movement instructions.

Example 53 is the apparatus of any one of examples 37 to 52, the apparatus further including a means for receiving (e.g., via a wireless transceiver) the energy requirements (e.g., from a provider of the supply of electricity) or a means for transmitting (e.g., via a wireless transceiver) the movement instructions to the vehicle.

Example 54 is the apparatus of any one of examples 37 to 53, wherein the energy requirements include a request from the supply for the vehicle to connect to the supply.

Example 55 is a non-transitory computer-readable medium that includes instructions which, if executed, cause one or more processors to determine an energy plan for a vehicle based on energy requirements about a supply of electricity to which the vehicle is capable of dispensing electrical charge, wherein the energy plan includes plans for dispensing electrical charge from the vehicle to the supply. The instructions also cause the one or more processors to generate movement instructions for the vehicle based on the energy plan.

Example 56 is non-transitory computer-readable medium of example 55, wherein the energy requirements include a cost associated with withdrawing electrical charge from the supply or with dispensing electrical charge to the supply.

Example 57 is the non-transitory computer-readable medium of example 56, wherein the cost includes a forecasted cost associated with withdrawing electrical charge from the supply at a future time or with dispensing electrical charge to the supply at the future time.

Example 58 is the non-transitory computer-readable medium of any one of examples 55 to 57, wherein the energy requirements include an available amount of energy offered from the supply or demanded by the supply.

Example 59 is the non-transitory computer-readable medium of example 58, wherein the available amount of energy includes a forecasted available amount of energy offered from the supply at a future time or demanded by the supply at the future time.

Example 60 is the non-transitory computer-readable medium of any one of examples 55 to 59, wherein the energy plan includes a time or location for withdrawing electrical charge from or dispensing electrical charge to the supply.

Example 61 is the non-transitory computer-readable medium of any one of examples 55 to 60, wherein vehicle is configured to withdraw electrical charge from or dispense electrical charge to the supply through a charging station.

Example 62 is the on-transitory computer-readable medium of any one of examples 55 to 61, wherein the energy plan further comprises plans for withdrawing electrical charge from the supply.

Example 63 is the non-transitory computer-readable medium of any one of examples 55 to 62, wherein the plans for dispensing electrical charge to (or withdrawing electrical charge from) the supply include at least one of a time of the dispensing (or withdrawing), a location of the dispensing (or withdrawing), and an amount of electricity associated with the dispensing (or withdrawing).

Example 64 is the non-transitory computer-readable medium of any one of examples 55 to 63, wherein the movement instructions include at least one of a planned route for the vehicle, a driving speed of the vehicle, a stopping time for the vehicle, a destination for the vehicle, a driving style of the vehicle, and a distance for the vehicle to travel.

Example 65 is the non-transitory computer-readable medium of any one of examples 55 to 64, wherein the energy plan is further based on additional parameters including one or more of a predefined destination of the vehicle, a predefined driving profile of the vehicle, a maximum duration for the vehicle to travel to the predefined destination, a maximum energy cost for the vehicle to travel to the predefined destination, a latest arrival time for the vehicle to arrive at the predefined destination, an earliest arrival time for the vehicle to arrive at the predefined destination, a maximum energy consumption of the vehicle to arrive at the predefined destination, a minimum energy consumption of the vehicle to arrive at the predefined destination, a maximum battery level to which a storage battery of the vehicle may be filled, and a minimum battery level to which the storage battery may be depleted.

Example 66 is the non-transitory computer-readable medium of example 65, wherein the instructions that cause the one or more processors to determine the energy plan includes instructions that cause the one or more processors to prioritize the plans based on the additional parameters and according to a predefined criterion associated with the plans and additional parameters.

Example 67 is the non-transitory computer-readable medium of any one of examples 55 to 66, wherein the supply of electricity includes a power grid to which the vehicle may connect in order to discharge an electrical storage of the vehicle or to charge the electrical storage of the vehicle.

Example 68 is the non-transitory computer-readable medium of example 67, wherein the electrical storage includes a rechargeable battery.

Example 69 is the non-transitory computer-readable medium of any one of examples 55 to 68, wherein the instructions further cause the one or more processors to cause a battery of the vehicle to dispense electrical charge from the battery to the supply or to withdraw electrical charge from the supply to the battery.

Example 70 is the non-transitory computer-readable medium of any one of examples 55 to 69, wherein the instructions further cause the one or more processors to store (e.g., in a memory) at least one of the movement instructions, the energy plan, and a function that relates the energy plan to the movement instructions.

Example 71 is the non-transitory computer-readable medium of any one of examples 55 to 70, wherein the instructions further cause the one or more processors to receive (e.g., via a receiver or transceiver) the energy requirements (e.g., from a provider of the supply of electricity) or to transmit (e.g., via a transmitter or transceiver) the movement instructions to the vehicle.

Example 72 is the non-transitory computer-readable medium of any one of examples 55 to 71, wherein the energy requirements include a request from the supply for the vehicle to connect to the supply.

While the disclosure has been particularly shown and described with reference to specific aspects, it should be understood by those skilled in the art that various changes in form and detail may be made therein without departing from the spirit and scope of the disclosure as defined by the appended claims. The scope of the disclosure is thus indicated by the appended claims and all changes, which come within the meaning and range of equivalency of the claims, are therefore intended to be embraced.

1.-25. (canceled)

26. A device comprising:
a processor configured to:
determine an energy plan for a vehicle based on energy requirements about a supply of electricity to which the vehicle is capable of dispensing electrical charge, wherein the energy plan comprises plans for dispensing electrical charge from the vehicle to the supply; and
generate movement instructions for the vehicle based on the energy plan.

27. The device of claim 26, wherein the energy requirements comprise a cost associated with withdrawing electrical charge from the supply or with dispensing electrical charge to the supply.

28. The device of claim 27, wherein the cost comprises a forecasted cost associated with withdrawing electrical charge from the supply at a future time or with dispensing electrical charge to the supply at the future time.

29. The device of claim 26, wherein the energy requirements comprise an available amount of energy offered from the supply or demanded by the supply.

30. The device of claim 29, wherein the available amount of energy comprises a forecasted available amount of energy offered from the supply at a future time or demanded by the supply at the future time.

31. The device of claim 26, wherein the energy plan comprises a time or location for withdrawing electrical charge from or dispensing electrical charge to the supply.

32. The device of claim 26, wherein the plans for dispensing electrical charge to the supply comprise at least one of a time of the dispensing, a location of the dispensing, and an amount of electricity associated with the dispensing.

33. The device of claim 26, wherein the movement instructions comprise at least one of a planned route for the vehicle, a driving speed of the vehicle, a stopping time for the vehicle, a destination for the vehicle, a driving style of the vehicle, and a distance for the vehicle to travel.

34. The device of claim 26, wherein the energy plan is further based on additional parameters comprising one or more of a predefined destination of the vehicle, a predefined driving profile of the vehicle, a maximum duration for the vehicle to travel to the predefined destination, a maximum energy cost for the vehicle to travel to the predefined destination, a latest arrival time for the vehicle to arrive at the predefined destination, an earliest arrival time for the vehicle to arrive at the predefined destination, a maximum energy consumption of the vehicle to arrive at the predefined destination, a minimum energy consumption of the vehicle to arrive at the predefined destination, a maximum battery level to which a storage battery of the vehicle may be filled, and a minimum battery level to which the storage battery may be depleted.

35. The device of claim 34, wherein the processor configured to determine the energy plan comprises the processor configured to prioritize the plans based on the additional parameters and according to a predefined criterion associated with the plans or additional parameters.

36. The device of claim 26, the device further comprising a battery of the vehicle, wherein the battery is configurable to dispense electrical charge from the battery to the supply or withdraw electrical charge from the supply to the battery.

37. The device of claim 26, the device further comprising a memory configured to store at least one of the movement instructions, the energy plan, and a function that relates the energy plan to the movement instructions.

38. The device of claim 26, the device further comprising a wireless transceiver configured to receive the energy requirements or to transmit the movement instructions to the vehicle.

39. The device of claim 26, wherein the energy requirements comprise a request from the supply for the vehicle to connect to the supply.

40. An apparatus for configuring a vehicle, the apparatus comprising:
a means for determining an energy plan for the vehicle based on energy requirements about a supply of electricity to which the vehicle is capable of dispensing electrical charge, wherein the energy plan includes plans for dispensing electrical charge from the vehicle to the supply; and
a means for generating movement instructions for the vehicle based on the energy plan.

41. The apparatus of claim 40, wherein the energy requirements include a cost associated with withdrawing electrical charge from the supply or with dispensing electrical charge to the supply, wherein the cost includes a forecasted cost associated with withdrawing electrical charge from the supply at a future time or with dispensing electrical charge to the supply at the future time.

42. A non-transitory computer-readable medium that comprises instructions which, if executed, cause one or more processors to:
determine an energy plan for a vehicle based on energy requirements about a supply of electricity to which the vehicle is capable of dispensing electrical charge, wherein the energy plan includes plans for dispensing electrical charge from the vehicle to the supply; and
generate movement instructions for the vehicle based on the energy plan.

43. The non-transitory computer-readable medium of claim 42, wherein the energy requirements include a cost associated with withdrawing electrical charge from the supply or with dispensing electrical charge to the supply.

44. The non-transitory computer-readable medium of claim 43, wherein the cost includes a forecasted cost associated with withdrawing electrical charge from the supply at a future time or with dispensing electrical charge to the supply at the future time.

45. The non-transitory computer-readable medium of claim 42, wherein the energy requirements include an available amount of energy offered from the supply or demanded by the supply.
